(19) United States
(12) Patent Application Publication
(10) Pub. No.: US 2025/0262782 A1
(43) Pub. Date: Aug. 21, 2025

(54) KNIFE SHEATH

(71) Applicant: Andrew Henry, Bloomington, IN (US)

(72) Inventor: Andrew Henry, Bloomington, IN (US)

(21) Appl. No.: 19/054,786

(22) Filed: Feb. 15, 2025

Related U.S. Application Data
(60) Provisional application No. 63/554,966, filed on Feb. 17, 2024.

(51) Int. Cl. B26B 29/02

(52) U.S. Cl. CPC B26B 29/02

(57) ABSTRACT

A sheath configured to hold both a knife and a training knife, but not both at the same time. The knife includes a sharpened blade, while the training knife has a dull blade. An example knife sheath comprises a blade compartment configured to accommodate a knife blade. The blade compartment defines a mouth opening through which the knife blade is inserted and removed and includes a tapered tip configured to capture the forward-most tip of the knife blade, thereby securing the knife within the sheath.

### CROSS-REFERENCE TO RELATED APPLICATION(S)

This application claims the benefit of U.S. Provisional Application Ser. No. 63/554,966, filed on Feb. 17, 2024, the entirety of which is incorporated herein by reference.

### TECHNICAL FIELD

This disclosure relates to implementations of a knife sheath.

### BACKGROUND

Knife sheaths are typically designed to accommodate a single type of blade, either a sharp blade or a blunt training version, but not both. In many instances, those who use knives for training purposes, such as martial arts and combatives, would prefer a knife sheath that can accommodate both the live blade and its corresponding training counterpart. Current knife sheaths often fail to meet this dual-purpose need, resulting in the necessity of carrying separate sheaths for each blade type.

Furthermore, knife sheaths designed for live blades are often unsuitable for blunt training analogs due to differences in size and shape. There remains a need for a knife sheath configured to hold both a sharp knife and a blunt training analog securely.

Accordingly, there is a need for the knife sheath disclosed herein. The present invention is directed to providing a knife sheath configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a sheath configured to hold both a knife and a training knife, but not both at the same time. The knife includes a sharpened blade, while the training knife has a dull blade.

An example knife sheath comprises a blade compartment configured to accommodate a knife blade. The blade compartment defines a mouth opening through which the knife blade is inserted and removed and includes a tapered tip configured to capture the forward-most tip of the knife blade, thereby securing the knife within the sheath.

Another example knife sheath comprises a first sheath half and a second sheath half that are fastened together to form a blade compartment therebetween. The blade compartment is configured to accommodate a knife blade and defines a mouth opening through which the knife blade is inserted and removed. The blade compartment includes a tapered tip configured to capture the forward-most tip of the knife blade, thereby securing the knife within the sheath.

In some implementations, the tapered tip of the blade compartment is formed between a pair of opposing sidewalls. The pair of opposing sidewalls are angled to form a tapered space therebetween and are configured to flex outward when the forward-most tip of the blade is inserted into the tapered tip.

### BRIEF DESCRIPTION OF THE DRAWINGS

FIG. 1 is a perspective view of a knife sheath according to the principles of the present disclosure.

FIG. 2 is another perspective view of the knife sheath shown in FIG. 1.

FIG. 3 is a plan view of the knife sheath shown in FIG. 1.

FIG. 4 is a side elevational view of the knife sheath shown in FIG. 1.

FIG. 5 is an exploded perspective view of the knife sheath shown in FIG. 1.

FIG. 6 is a plan view of the knife sheath shown in FIG. 1 holding a knife.

FIG. 6A is a cutaway view of the knife sheath and knife, taken along lines 6A-6A shown in FIG. 6.

FIG. 7 is a plan view of the knife sheath shown in FIG. 1 holding a training knife.

FIG. 8 is a plan view of both the knife and the training knife shown in FIGS. 6 and 7, respectively.

FIG. 9 is another plan view of both the knife and the training knife shown in FIGS. 6 and 7, respectively. The training knife is positioned to overlay the knife, showcasing that the sharpened tip of the knife extends past the blunted end of the training blade.

Like reference numerals refer to corresponding parts throughout the several views of the drawings.

### DETAILED DESCRIPTION

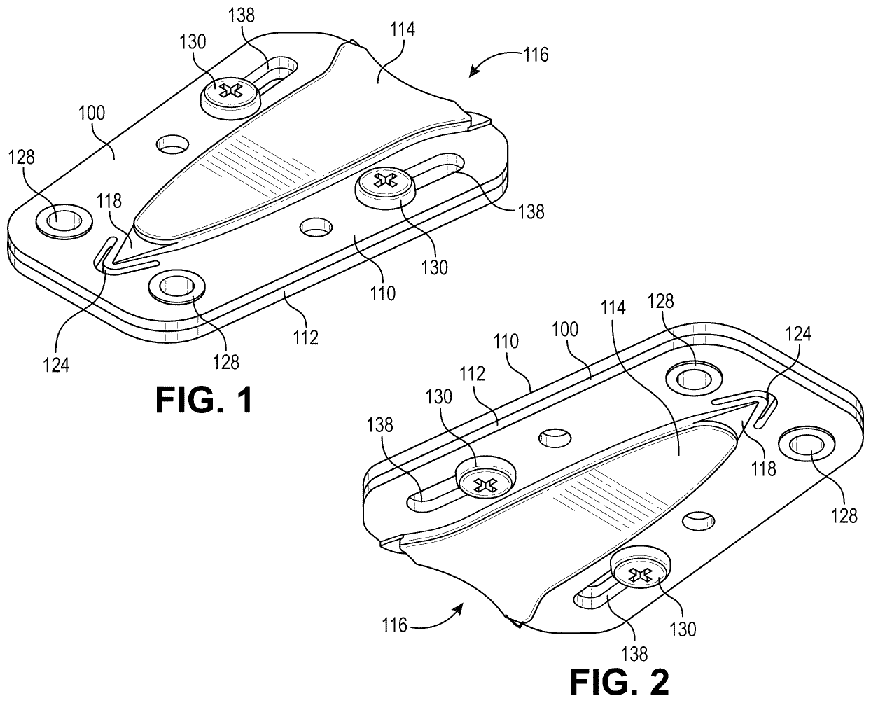

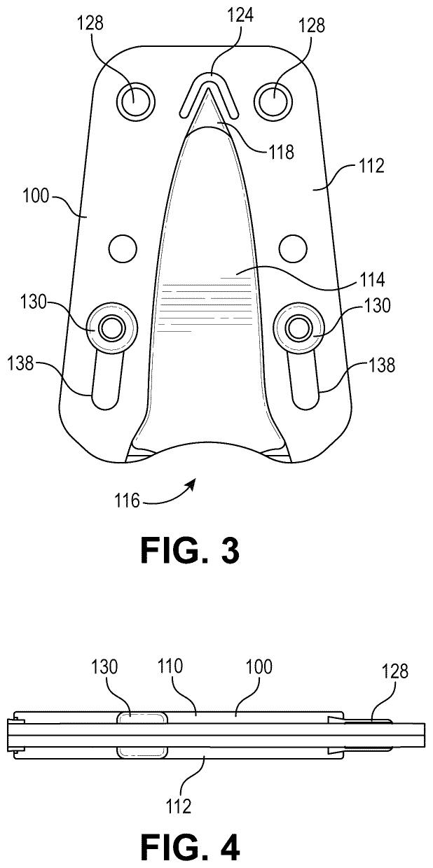

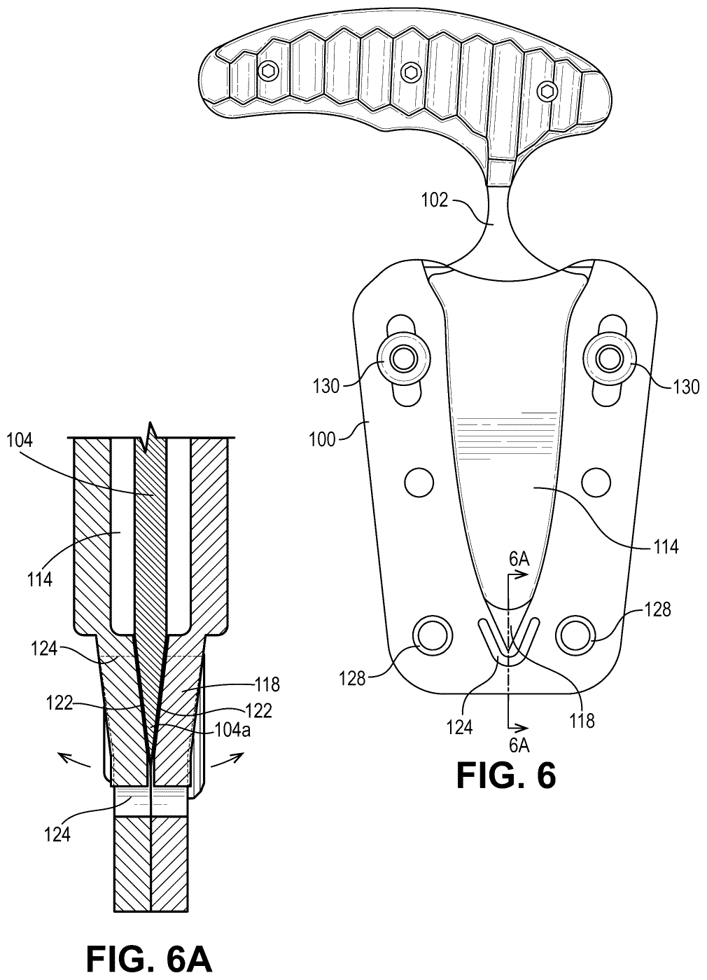

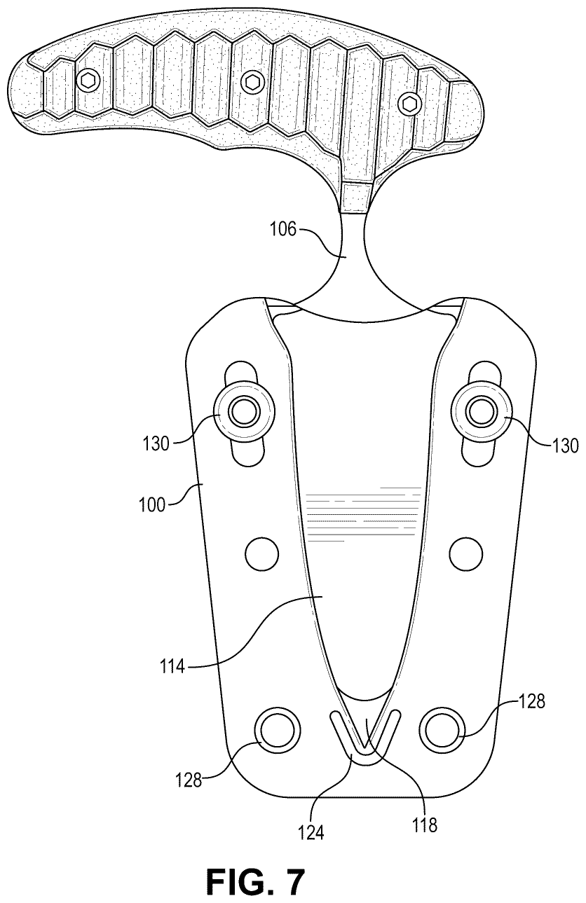

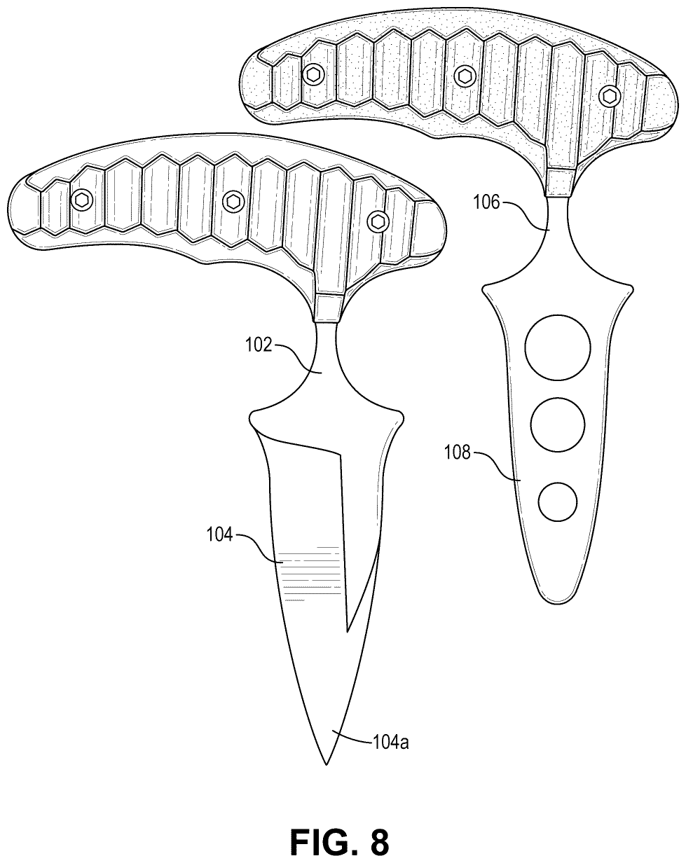

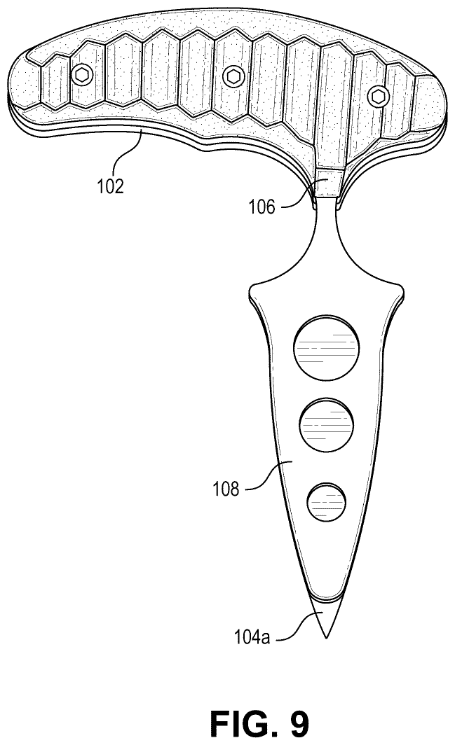

FIGS. 1-5 illustrate an example knife sheath 100 according to the principles of the present disclosure. As shown in FIGS. 6 and 7, the knife sheath 100 is configured to hold both a knife 102 and a training knife 106, but not both at the same time. The knife 102 includes a sharpened blade 104, while the training knife 106 has a dull blade 108 that is shorter in length and thicker than the blade of the knife 102 (see FIGS. 8 and 9). While the knife 102 shown is often referred to as a “push dagger,” the knife sheath 100 can be configured to work with other types of knives.

As shown in FIGS. 1-4, the knife sheath 100 comprises two symmetrical sheath halves 110, 112 fastened together. When assembled, the two sheath halves 110, 112 form a blade compartment 114 configured to accommodate either the sharpened blade 104 of the knife 102 (see FIG. 6) or the dull blade 108 of the training knife 106 (see FIG. 7), but not both at the same time. The blade compartment 114 defines a mouth opening 116 through which a knife blade is inserted into and removed from the blade compartment 114. Additionally, as shown in FIG. 6A, the blade compartment 114 includes a tapered tip 118 configured to capture the tip 104a of the sharpened blade 104, securing the knife 102 in place and preventing it from rattling within the knife sheath 100 during movement.

While the example blade compartment 114 is formed between two symmetrical sheath halves (110, 112), it should be understood that the blade compartment 114, including the tapered tip 118, could be incorporated into a one-piece knife sheath design produced using thermoforming, injection molding, or additive manufacturing.

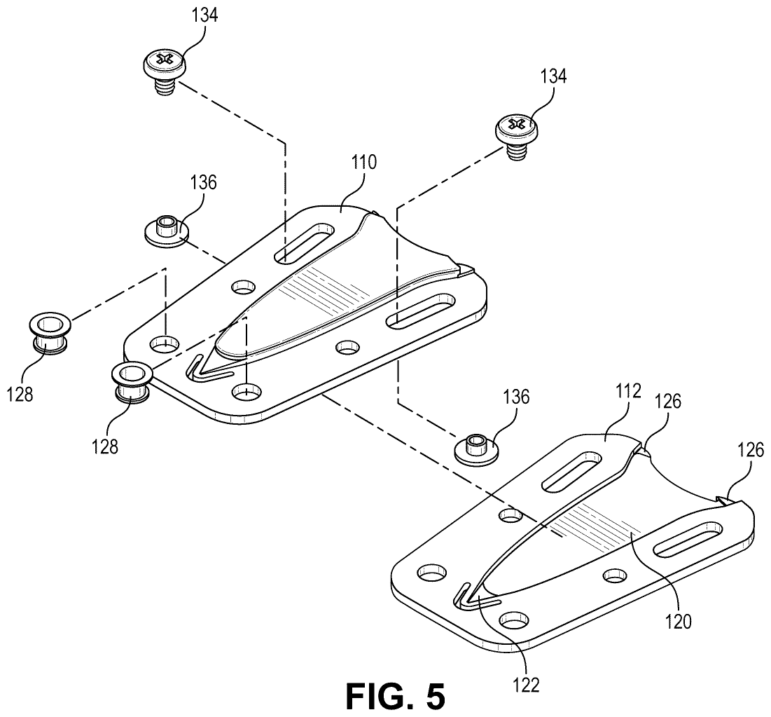

As shown best in FIG. 5, each half 110, 112 of the knife sheath 100 defines a compartment segment 120 that, when assembled with its counterpart, forms the complete blade compartment 114. As shown in FIG. 6A, the tapered tip 118 of the blade compartment 114 is formed between a pair of opposing, tapered sidewalls 122. The sidewalls 122 are angled to form a tapered space between them and are configured to flex outward when the tip 104a of the sharpened blade 104 is inserted into the tapered tip 118 of the blade compartment 114. The tapered tip 118 is outlined by a groove 124, which is a curved relief cut extending through the material that is configured to facilitate the outward flex of the tapered sidewalls 122 (see, e.g., FIG. 6). The groove 124 disconnects each of the tapered sidewalls 122 from adjacent material to form a “living spring” element that applies pressure against a side of the blade tip 104 while the knife 102 is sheathed within the blade compartment 114.

While the example training knife 106 has a dull blade 108 that is shorter in length and thicker than the sharpened blade 104 of the knife 102, it should be understood that some training knives may include dull blades that are not shorter in length or thicker than their sharp counterpart. As such, the tapered tip 118 of the blade compartment 114 could be configured to capture the forward-most tip of both a live blade and a dull blade in some knife designs.

In the example implementation, the two halves 110, 112 of the knife sheath 100 are fastened together using a pair of eyelets 128 and a pair of Chicago screws 130. Each eyelet 128 is made of brass and defines therein an axial center hole 132. Each Chicago screw 130 consists of a male threaded screw 134 and a female threaded barrel 136, designed to interlock. Each Chicago screw 130 is slidably disposed within a slot 138 in each side of the knife sheath 100. Each slot 138, composite in nature, is formed by aligning matching slots in each sheath half 110, 112. When the sheath halves 110, 112 are fastened together, these individual slots align to create a single, cohesive slot 138. While the example implementation of the knife sheath 100 uses eyelets 128 and Chicago screws 130, other fasteners or combinations of fasteners could be used to fasten the sheath halves 110, 112 together without departing from the scope of the present invention.

Adjusting the position of the Chicago screws 130 within their respective slots 138 allows for adjustment of the knife sheath's 100 retention. Moving the Chicago screws 130 towards the end of each slot 138 closest to the mouth opening 116 of the blade compartment 114 tightens this opening. This tightening means the mouth opening 116 is less able to deflect open, thereby increasing the retention of the knife sheath 100. Conversely, moving the Chicago screws 130 towards the opposite end of their respective slots 138 decreases the retention of the knife sheath 100 (see, e.g., FIG. 1).

In the example implementation, the mouth opening 116 of the blade compartment 114 includes four retention lips 126 configured to assist with retaining a knife in the sheath 100. Each retention lip 126 is integral with one of the sheath halves 110, 112 or it can be fixedly attached to it. Each retention lip 126 may have any shape or type of protrusion but is preferably sized and formed to catch on a portion of a sheathed blade. In other implementations, the mouth opening 116 may have fewer than four retention lips 126, or it may not include any at all.

Each half 110, 112 of the knife sheath 100 is made of a thermoplastic material, such as Kydex® or Boltaron® thermoplastic sheets. While the preferred implementation utilizes material that is 0.093 inches thick, other implementations may be fabricated from materials that are thicker or thinner. Additionally, in some implementations, the sheath halves 110, 112 could be made of an injection molded plastic.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A sheath for a knife, the sheath comprising:
a first sheath half; and
a second sheath half;
wherein:
the first sheath half and the second sheath half are fastened together to form a blade compartment therebetween, the blade compartment is configured to accommodate a blade of the knife;
the blade compartment defines a mouth opening through which the blade of the knife is inserted and removed; and
the blade compartment includes a tapered tip configured to capture a forward-most tip of the blade, thereby securing the knife within the sheath.

2. The sheath of claim 1, wherein the tapered tip of the blade compartment is formed between a pair of opposing sidewalls, the pair of opposing sidewalls being angled to form a tapered space therebetween and configured to flex outward when the forward-most tip of the blade is inserted into the tapered tip.

3. The sheath of claim 2, wherein the tapered tip is outlined by a groove, the groove being a curved relief cut that extends through both the first sheath half and the second sheath half and is configured to facilitate the outward flex of the pair of opposing sidewalls.

4. A sheath for a knife, the sheath comprising:
a blade compartment configured to accommodate a blade of the knife;
the blade compartment defines a mouth opening through which the blade of the knife is inserted and removed; and
the blade compartment includes a tapered tip configured to capture a forward-most tip of the blade, thereby securing the knife within the sheath.

5. The sheath of claim 4, wherein the tapered tip of the blade compartment is formed between a pair of opposing sidewalls, the pair of opposing sidewalls being angled to form a tapered space therebetween and configured to flex outward when the forward-most tip of the blade is inserted into the tapered tip.

6. The sheath of claim 5, wherein the tapered tip is outlined by a groove, the groove being a curved relief cut that extends through the sheath and is configured to facilitate the outward flex of the pair of opposing sidewalls.
